(19) United States
(12) Patent Application Publication
(10) Pub. No.: US 2009/0199827 A1
(43) Pub. Date: Aug. 13, 2009

(54) Flux director for ignition coil assembly

(76) Inventors: Albert A. Skinner, El Paso, TX (US); Andre V. Scaff, CD Juarez (MX); Harry O. Levers, JR., El Paso, TX (US)

Correspondence Address: DELPHI TECHNOLOGIES, INC., M/C 480-410-202, PO BOX 5052, TROY, MI, 48007, US

(21) Appl. No.: 12/069,339

(22) Filed: Feb. 8, 2008

(51) Int. Cl. H01F 38/12

(52) U.S. Cl. 123/634

(57) ABSTRACT

An ignition coil has a primary core supporting a primary winding that is connectable to an engine ignition system and a secondary winding inductively couplable to the primary winding and surrounding the primary winding. The secondary winding can be connected to an engine spark plug assembly. A flux director surroundingly engages the core. The flux director is a single, unitary piece of steel that is not made of composite Iron particles.

### FIELD OF THE INVENTION

The present invention relates to vehicle ignition coils.

### BACKGROUND OF THE INVENTION

Ignition coils are components that use the coupling between a primary winding and a secondary winding to transform relatively low voltages from the battery into high voltages that are supplied to the spark plugs in vehicle gasoline engines. The spark plugs start the internal combustion process that drives the rods and hence, crankshaft and axles. In older systems, a single ignition coil is provided, and a distributor sends the pulses from the coil through respective high voltage spark plug wires to the spark plugs in the cylinders in accordance with a timing that is established by the distributor.

In relatively modern engines, an engine can have several ignition coils, one for each cylinder or for each pair of cylinders, thereby advantageously eliminating the need for distributors and high voltage wires and also providing more precise control of the engine timing. One example of such an ignition coil system is set forth in U.S. Pat. No. 6,556,118, owned by the present assignee and incorporated herein by reference.

When such a coil is used to energize two spark plugs (either for two different cylinders or for a single cylinder in an engine that has two spark plugs per cylinder), two secondary windings surround the low voltage-carrying primary winding that is wound on an interior ferromagnetic core, with the secondary windings being radially spaced from the primary winding. Each secondary winding, owing to the inductive coupling between it and the primary winding and the different numbers of winding turns between the primary and secondary windings, produces a high voltage that is sent to a respective spark plug.

As understood herein, pole pieces can be coupled to the core for purposes of advantageously directing magnetic flux. As also understood herein, however, existing pole pieces typically are made of coated iron powder and cannot be press fit onto the core, requiring a relatively complex support to hold the pole piece onto the core. The present invention understands that the support reduces the area available for the primary winding, thereby undesirably increasing the length of the core required to support the winding.

### SUMMARY OF THE INVENTION

An ignition coil has a core supporting a primary winding that can be connected to an engine ignition system and one or more secondary windings inductively couplable to the primary winding and surrounding the primary winding, with the secondary winding being connectable to an engine spark plug assembly. A flux director surroundingly engages the core. The flux director is a single, unitary piece of steel that is not made of composite Iron particles.

For example, the flux director may be made by stamping 65A800 steel. If desired, one or more thin laminations configured identically to the flux director in transverse cross-section may be provided. The flux director can be U-shaped in transverse cross-section and can be formed with a round central cavity for receiving the core therein. With the above structure only smooth formed edges of the flux director face toward the primary winding of the core to minimize stress concentration, with sharp edges formed by corners of the flux director facing away from the windings.

A wire support may also be provided on the core to connect the primary winding to an ignition system. The wire support can be a relatively simple and advantageously thin support having a thickness “t” of no more than about one-half millimeter.

In some implementations the flux director has an annular inner lip pressed against the core and an outer annular skirt lengthened along an axis of the core in the direction of flux.

In another aspect, an ignition coil has a core supporting a primary winding that is connected to an engine ignition system and one or more secondary windings inductively couplable to the primary winding and surrounding the primary winding, with the secondary winding being connected to an engine spark plug assembly. A flux director that is not made of composite Iron particles surroundingly engages an end of the core.

In still another aspect, a method for making an ignition coil for an engine includes providing a core supporting a primary winding and configuring a terminal of the primary winding for connection to an engine ignition system. The method also includes providing a secondary winding configured for being inductively couplable to the primary winding and surrounding the primary winding, and configuring a terminal of the secondary winding for connection to an engine spark plug assembly. The method entails providing flux direction on the core without using composite Iron particles.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is an exploded perspective view of a non-limiting ignition coil in accordance with present principles, schematically showing the ignition system that energizes the primary winding;

FIG. 2 is a transverse cut-away view of the primary core with flux director and wire support;

FIG. 3 is a perspective view of the primary core with flux director and wire support; and

FIG. 4 is a schematic side view of the primary core with a flux director.

### DESCRIPTION OF THE PREFERRED EMBODIMENT

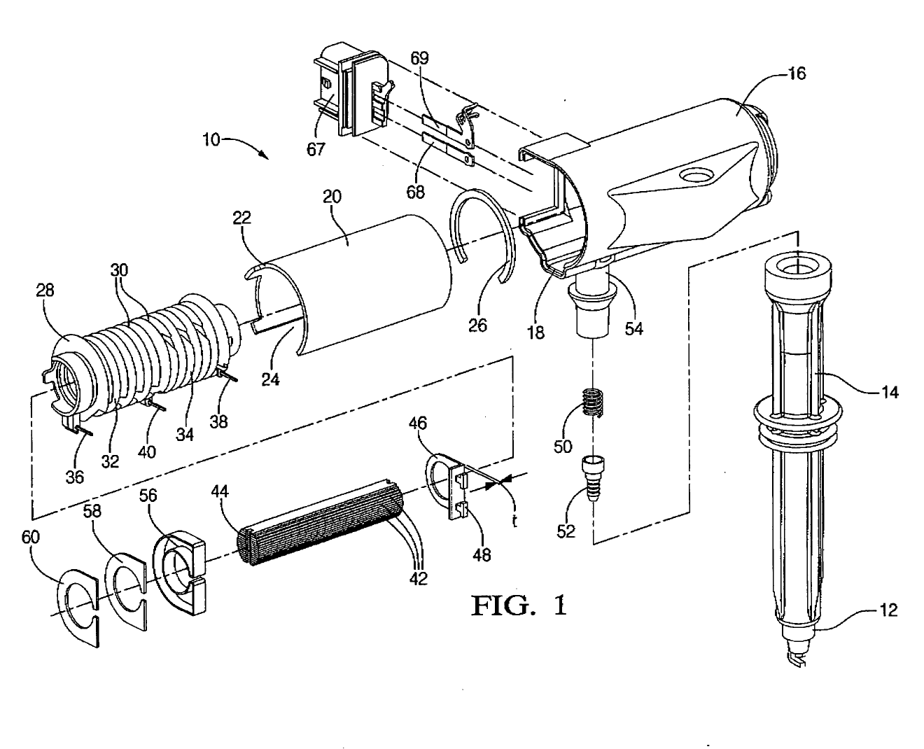

Referring initially to FIG. 1, an ignition coil is shown, generally designated 10, for use in energizing at least one spark plug (only a single spark 12 shown) that is disposed in a high voltage spark plug boot 14 and that extends into an engine cylinder. In non-limiting applications the ignition coil 10 can be but one of plural coils that would be used in an engine having more than two cylinders in a distributorless ignition system, i.e., no distributor exists between the ignition coil 10 and its spark plugs 12.

In the non-limiting embodiment shown, the ignition coil 10 includes a case 16 that defines a closable open end 18. An electrically conductive magnetic shield 20 made of, e.g., silicon steel, is disposed within the case 16 substantially coaxially with the case 16 to magnetically isolate the below-described windings from exterior components. As shown, an end 22 of the shield 20 is juxtaposed with the closable open end 18 of the case 16. In the embodiment shown the shield 20 defines a substantial portion of a cylinder, i.e., the shield 20 may define, for instance, an axial slit 24 in an otherwise cylindrical surface to limit eddy current losses in the shield. If desired, a rubber-like shield buffer ring 26 may be disposed between the shield 20 and case 16 to accommodate thermal expansion and contraction of the metal parts.

As shown in FIG. 1, the shield 20 closely surrounds a secondary winding spool 28 that is generally cylindrical and that has axially-spaced ribs 30 that together define a segmented winding path. At least one and, in the non-limiting embodiment shown, first and second electrically conductive wire secondary windings 32, 34 are disposed in the winding path defined by the spool 28 and are in axial sequence to each other. A spark plug end of the first secondary winding 32 is connected to a first terminal 36, while a spark plug end of the second secondary winding 34 is connected to a second terminal 38, it being understood that when the coil 10 is used to energize only a single spark plug, then only one secondary winding and, hence, only one terminal at the spark plug end of the secondary winding need be provided.

The ends of the secondary windings 32, 34 that are opposite to the spark plug ends are each connected to a center tap terminal 40, which may be established by one or more electrical conductors, e.g., by a wire having a square cross-section. The secondary windings 32, 34 may be wound oppositely to each other relative to the axial dimension of the coil 10. A dielectric material such as epoxy may be disposed between the secondary winding spool 28 and the case 16.

A primary wire winding 42 is wound around a soft iron core 44 that is coaxially disposed within the secondary winding spool 28. It is to be understood that the primary winding 42 is electrically connected, via a wire support 46, with two “T” posts 48 that allow the wires to be held in place until they are connected to terminals 68 and 69 in a connector housing 67. In turn, the connector housing 67 is configured to mate with a wiring harness of an ignition system “I” that selectively energizes the primary winding 42 from a source of voltage such as a vehicle battery or other part of an ignition system.

When the primary winding 42 is energized, the cooperation between the core 44, primary winding 42, and secondary windings 32, 34 results in inductive coupling between the primary winding 42 and secondary windings 32, 34. Owing to this coupling and to the different number of turns between primary and secondary, the relatively low battery voltage in the primary winding 42 is transformed into relatively higher voltages in the secondary windings 32, 34 for provision of the higher voltages to the spark plugs.

The non-limiting terminals 36, 38 of the secondary windings 32, 34 (when two secondary windings for energizing two spark plugs are provided) are connected to respective spark plugs using connector structure known in the art, e.g., each terminal 36, 38 may be electrically connected to a respective spring 50 with associated terminal cup 52. A so-called tower 54 may be formed as part of the case 16.

In accordance with the present invention and in cross-reference to FIGS. 1-3, at one end of the core 44 a flux director 56 is disposed. If required for greater energy levels, additional thin steel laminations 58 that are configured identically to the flux director 56 in transverse cross-section as shown may be pressed flush against the flux director and may be formed with dimples 60 for better securing the laminations 58 onto each other and the flux director 56.

In one embodiment the flux director 56 is a single, unitary piece of steel that consequently is not made of composite Iron particles. The flux director 56 may be made by stamping, e.g., 65A800 steel into the configuration shown.

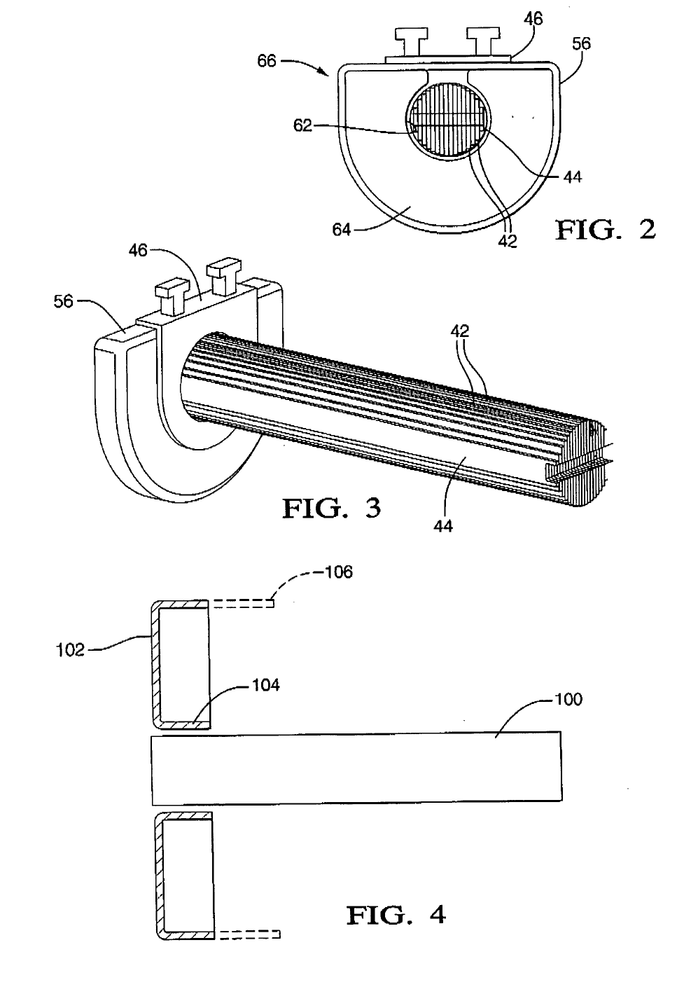

As best shown in FIG. 2, the flux director 56 may be U-shaped in transverse cross-section and is formed with a round central cavity 62 for closely receiving the core 44 therein. The cavity 62 may be open at the top as shown. With this structure, advantageously only smooth formed edges face toward the winding area of the core 44 to minimize stress concentration in epoxy 64 that may be deposited in the annular region between the flux director 56 and core 44 to hold the components together. Sharp edges indicated at 66 that are formed by the corners of the flux director 56 face away from the winding area and are pressed into the plastic case of the coil 10. Because the flux director 56 is a single unitary piece of steel requiring no complex holder, the wire support 46 may be a simple single piece structure as shown that is very thin, e.g., that may have a thickness “t” (FIG. 1) of one-half millimeter or so, to maximize the area of the core 44 that is available for the primary winding 42.

FIG. 4 shows that a primary core 100 may be engaged at one end with a single piece steel flux director 102 in accordance with present principles, with the flux director 102 having an annular inner lip 104 that is pressed against the core 100 and an outer annular skirt 106 that may be lengthened along the axis of the core 100 as shown in phantom as needed in the direction of flux.

While the particular FLUX DIRECTOR FOR IGNITION COIL ASSEMBLY is herein shown and described in detail, it is to be understood that the subject matter which is encompassed by the present invention is limited only by the claims.

What is claimed is:

1. An ignition coil, comprising:
at least one core supporting a primary winding, the primary winding being connectable to an engine ignition system;
at least one secondary winding inductively couplable to the primary winding, the secondary winding being connectable to an engine spark plug assembly; and
a flux director surroundingly engaging the core, the flux director being a single, unitary piece of steel that is not made of composite Iron particles.

2. The coil of claim 1, wherein the flux director is made by stamping.

3. The coil of claim 1, wherein the flux director is made 65A800 steel.

4. The coil of claim 1, further comprising at least one thin lamination configured identically to the flux director in transverse cross-section.

5. The coil of claim 1, wherein the flux director is U-shaped in transverse cross-section and is formed with a round central cavity for receiving the core therein.

6. The coil of claim 5, wherein only smooth formed edges of the flux director face toward the primary winding of the core to minimize stress concentration, with sharp edges formed by corners of the flux director facing away from the windings.

7. The coil of claim 1, comprising a wire support having a thickness “t” of no more than about one-half millimeter, the wire support for holding at least portions of the primary winding.

8. The coil of claim 1, wherein the flux director has an annular inner lip pressed against the core and an outer annular skirt lengthened along an axis of the core in the direction of flux.

9. An ignition coil assembly, comprising:
at least one core supporting a primary winding, the primary winding being connected to an engine ignition system;
at least one secondary winding inductively couplable to the primary winding and surrounding the primary winding, the secondary winding being connected to an engine spark plug assembly; and
a flux director not made of composite Iron particles surroundingly engaging an end of the core.

10. The coil of claim 9, wherein the flux director is a single, unitary piece of steel that is made by stamping.

11. The coil of claim 9, wherein the flux director is made 65A800 steel.

12. The coil of claim 9, further comprising at least one thin lamination configured identically to the flux director in transverse cross-section.

13. The coil of claim 9, wherein the flux director is U-shaped in transverse cross-section and is formed with a round central cavity for receiving the core therein.

14. The coil of claim 13, wherein only smooth formed edges of the flux director face toward the primary winding of the core to minimize stress concentration, with sharp edges formed by corners of the flux director facing away from the windings.

15. The coil of claim 9, comprising a wire support having a thickness “t” of no more than about one-half millimeter, the wire support for holding at least portions of the primary winding.

16. The coil of claim 9, wherein the flux director has an annular inner lip pressed against the core and an outer annular skirt lengthened along an axis of the core in the direction of flux.

17. A method for making an ignition coil for an engine, comprising:
providing a core supporting a primary winding;
configuring a terminal of the primary winding for connection to an engine ignition system;
providing at least one secondary winding configured for being winding inductively couplable to the primary winding and surrounding the primary winding;
configuring at least one terminal of the secondary winding for connection to an engine spark plug assembly; and
providing flux direction on the core without using composite Iron particles.

18. The method of claim 17, wherein the act of providing flux direction is undertaken by surroundingly engaging a single, unitary piece of steel with the core, the single piece of steel establishing a flux director.

19. The method of claim 18, further comprising providing at least one thin lamination configured identically to the flux director in transverse cross-section.

20. The method of claim 18, wherein the flux director is U-shaped in transverse cross-section and is formed with a round central cavity for receiving the core therein, and the method further includes providing a primary winding wire support having a thickness “t” of no more than about one-half millimeter.
